(19) United States
(12) Patent Application Publication
(10) Pub. No.: US 2026/0300992 A1
(43) Pub. Date: Oct. 1, 2026

(54) SUPPORT DEVICE, SUPPORT METHOD, AND RECORDING MEDIUM

(71) Applicant: NEC Corporation, Tokyo (JP)

(72) Inventors: Toshihiko IMAI, Tokyo (JP); Marina ADACHI, Tokyo (JP); Shingo MORIGAKI, Tokyo (JP); Wataru TAKAYANAGI, Tokyo (JP); Kentaro MAEDA, Tokyo (JP)

(73) Assignee: NEC Corporation, Tokyo (JP)

(21) Appl. No.: 19/630,818

(22) Filed: Mar. 27, 2026

(30) Foreign Application Priority Data
Apr. 1, 2025 (JP) 2025-060243

(51) Int. Cl. G06Q 30/015

(52) U.S. Cl. CPC G06Q 30/015

(57) ABSTRACT

A support device includes an inquiry acquisition unit for acquiring an inquiry from a user, an identification unit for referring to an inquiry-answer collection in which an inquiry acquired in the past, an answer to the inquiry, an answer date and time, and a rule as a basis of the answer are associated with each other, and identifying a past inquiry similar to the inquiry from the user, a rule change history acquisition unit for acquiring a change history of the rule associated with the identified inquiry, a determination unit for comparing the change history with the answer date and time associated with the identified inquiry and determining whether the rule associated with the identified inquiry has been changed after the answer date and time, and an output unit for outputting output information including the answer associated with the identified inquiry and a result of the determination.

### CROSS-REFERENCE TO RELATED APPLICATIONS

This application is based upon and claims the benefit of priority from Japanese Patent Application No. 2025-060243, filed on Apr. 1, 2025, the disclosure of which is incorporated herein in its entirety by reference.

### TECHNICAL FIELD

The present disclosure relates to a support device, a support method, and a recording medium.

### BACKGROUND ART

A technique for supporting work of a help desk worker is known. The help desk is a contact point where a user requests support for a problem related to a service, a product, or a system. For example, JP 2011-257824 A discloses a technique of identifying content data similar to content of a frequently asked question (FAQ) page among content data in a company site, and pasting, to the FAQ page, a uniform resource locator (URL) associated with the identified content data as a related URL.

### SUMMARY

An object of the present disclosure is to provide a support device, a support method, and a recording medium for supporting a help desk worker to be able to answer a question from a user based on a current rule.

A support device according to one aspect of the present disclosure includes an inquiry acquisition means for acquiring an inquiry from a user, an identification means for referring to an inquiry-answer collection in which the inquiry acquired in the past, an answer to the inquiry, an answer date and time indicating a date and time at which the answer is made, and a rule as a basis of the answer are associated with each other, and identifying a past inquiry similar to the inquiry from the user, a rule change history acquisition means for acquiring a change history of the rule associated with the identified inquiry, a determination means for comparing the change history with the answer date and time associated with the identified inquiry and determining whether the rule associated with the identified inquiry has been changed after the answer date and time, and an output means for outputting output information including the answer associated with the identified inquiry and a result of the determination.

A support method according to one aspect of the present disclosure causes a computer to execute acquiring an inquiry from a user, referring to an inquiry-answer collection in which the inquiry acquired in the past, an answer to the inquiry, an answer date and time indicating a date and time at which the answer is made, and a rule as a basis of the answer are associated with each other, and identifying a past inquiry similar to the inquiry from the user, acquiring a change history of the rule associated with the identified inquiry, comparing the change history with the answer date and time associated with the identified inquiry and determining whether the rule associated with the identified inquiry has been changed after the answer date and time, and outputting output information including the answer associated with the identified inquiry and a result of the determination.

A computer program according to one aspect of the present disclosure causes a computer to execute processing of acquiring an inquiry from a user, processing of referring to an inquiry-answer collection in which the inquiry acquired in the past, an answer to the inquiry, an answer date and time indicating a date and time at which the answer is made, and a rule as a basis of the answer are associated with each other, and identifying a past inquiry similar to the inquiry from the user, processing of acquiring a change history of the rule associated with the identified inquiry, processing of comparing the change history with the answer date and time associated with the identified inquiry and determining whether the rule associated with the identified inquiry has been changed after the answer date and time, and processing of outputting output information including the answer associated with the identified inquiry and a result of the determination.

### BRIEF DESCRIPTION OF THE DRAWINGS

Exemplary features and advantages of the present disclosure will become apparent from the following detailed description if taken with the accompanying drawings in which:

FIG. 1 is a conceptual diagram for explaining an overview of a support system in the present disclosure;

FIG. 2 is a block diagram illustrating an example of a configuration of a support device in the present disclosure;

FIG. 3 is a diagram illustrating an example of an inquiry-answer collection in the present disclosure;

FIG. 4 is a diagram illustrating an example of a rule change table in the present disclosure;

FIG. 5 is a diagram illustrating an example of output information in the present disclosure;

FIG. 6 is a flowchart illustrating an example of an operation of the support device in the present disclosure;

FIG. 7 is a block diagram illustrating an example of the configuration of the support device in the present disclosure;

FIG. 8 is a diagram illustrating an example of an input request screen in the present disclosure;

FIG. 9 is a flowchart illustrating an example of the operation of the support device in the present disclosure;

FIG. 10 is a block diagram illustrating an example of the configuration of the support device in the present disclosure;

FIG. 11 is a flowchart illustrating an example of the operation of the support device in the present disclosure; and

FIG. 12 is a diagram illustrating an example of a hardware configuration in which the support device in the present disclosure is achieved by a computing device including a processor.

### EXAMPLE EMBODIMENT

Hereinafter, example embodiments in the present disclosure will be described in detail while referring to the drawings. The example embodiments described below have technically preferable limitations for carrying out the present disclosure; however, it is not intended to limit the scope of the disclosure to the following. In all the drawings used in the following description of the example embodiments, the same reference signs are given to similar sections unless otherwise specified. In the following example embodiments, repeated description of similar configurations and operations is omitted in some cases. A user interface (UI) illustrated in the drawings is an example, and may be replaced with another UI.

### First example embodiment

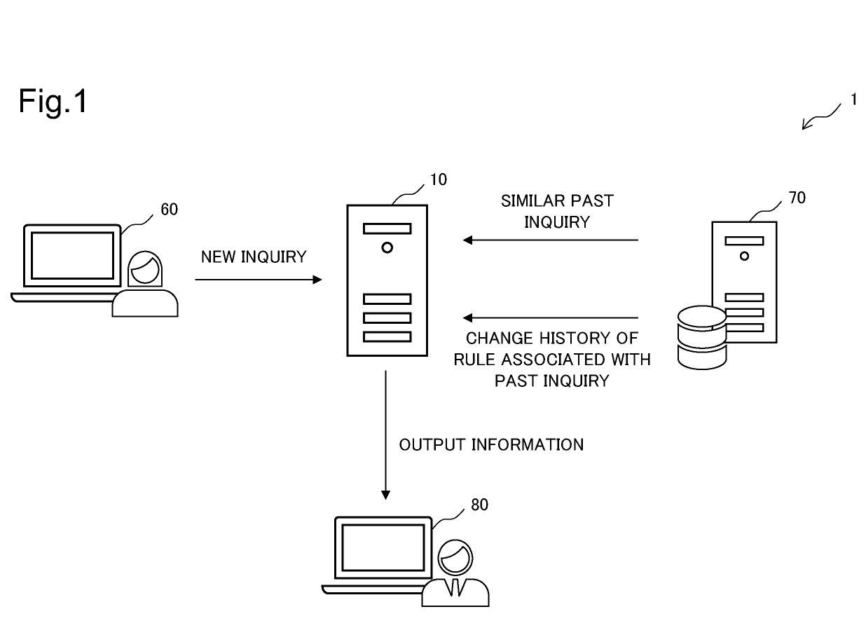

First, an overview of a support system in a first example embodiment will be described while referring to the drawings. FIG. 1 is a conceptual diagram for explaining the overview of the support system in the present disclosure. An overview of a processing flow of a support system 1 will be described with reference to FIG. 1.

First, a support device 10 acquires a new inquiry of a user from a user terminal 60. FIG. 1 illustrates that the new inquiry is acquired from the user terminal 60, but the present disclosure is not limited thereto. The new inquiry may be acquired from a worker terminal 80. The support device 10 refers to an inquiry-answer collection stored in a database server 70, and identifies a past inquiry similar to the new inquiry. The inquiry-answer collection is data obtained by collecting an inquiry accepted in the past and an answer to the inquiry. In the inquiry-answer collection, an inquiry, an answer to the inquiry, an answer date and time, and information regarding a rule that is a basis of the answer are stored in association. Details of the inquiry-answer collection will be described later. In addition, the support device 10 refers to a rule database stored in the database server 70, and acquires a change history of the rule associated with the inquiry identified to be similar. The rule database is a database including a change history for each rule. Details of the rule database will be described later. The support device 10 compares the change history with the answer date and time associated with the identified inquiry, and determines whether the rule associated with the inquiry has been changed after the answer date and time. The support device 10 outputs, to the worker terminal 80, output information including the answer to the identified inquiry and a result of the determination.

The user terminal 60 is an information processing device operated by a user who requests support from a help desk. For example, the user terminal 60 is achieved by a stationary terminal device, a portable terminal device, or a general-purpose information processing device such as a server. In the example of FIG. 1, the number of the user terminals 60 is one, but this is an example. The number of the user terminals 60 may be plural.

The database server 70 is an information processing device that stores a database required for processing of the support device 10. The database server 70 stores a database that stores the inquiry-answer collection. In addition, the database server 70 stores a rule database that stores a change history for each rule. In the example of FIG. 1, the number of the database servers 70 is one, but this is an example. The number of the database servers 70 may be plural.

The worker terminal 80 is a terminal device operated by a help desk worker. For example, the worker terminal 80 is achieved by a stationary terminal device, a portable terminal device, or a general-purpose information processing device such as a server. In the example of FIG. 1, the number of the worker terminals 80 is one, but this is an example. The number of the worker terminals 80 may be plural.

### Configuration

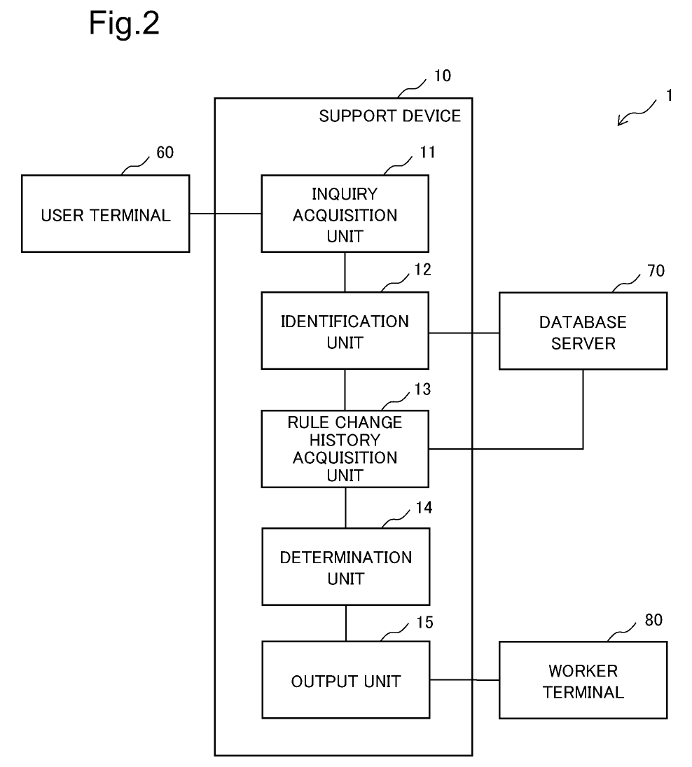

Next, a configuration of the support device will be described using FIG. 2. FIG. 2 is a block diagram illustrating an example of the configuration of the support device in the present disclosure.

The support device 10 is achieved by a stationary terminal device, a portable terminal device, or a general-purpose information processing device such as a server device. As illustrated in FIG. 2, the support device 10 is communicably connected to each of the user terminal 60, the database server 70, and the worker terminal 80.

As illustrated in FIG. 2, the support device 10 includes an inquiry acquisition unit 11, an identification unit 12, a rule change history acquisition unit 13, a determination unit 14, and an output unit 15.

The inquiry acquisition unit 11 acquires an inquiry from the user. The inquiry acquisition unit 11 acquires an inquiry from the user terminal 60 or the worker terminal 80. The inquiry includes a question sentence for a problem related to a service, a product, a system, or the like.

The inquiry acquisition unit 11 may summarize the question sentence included in the inquiry by a generative model. The generative model is, for example, a large language model (LLM). The inquiry acquisition unit 11 inputs, to the generative model, a question sentence and an instruction sentence instructing to summarize the question sentence. The instruction sentence is a prompt to be input to the generative model. For example, the instruction sentence may include an instruction to make an output format of a summary the same as a format of the inquiry stored in the inquiry-answer collection. In another example, the instruction sentence may include an instruction to keep a technical term included in the inquiry without changing the technical term.

The identification unit 12 refers to the inquiry-answer collection stored in the database server 70, and identifies a past inquiry similar to the inquiry from the user. The number of inquiries identified by the identification unit 12 may be one or more.

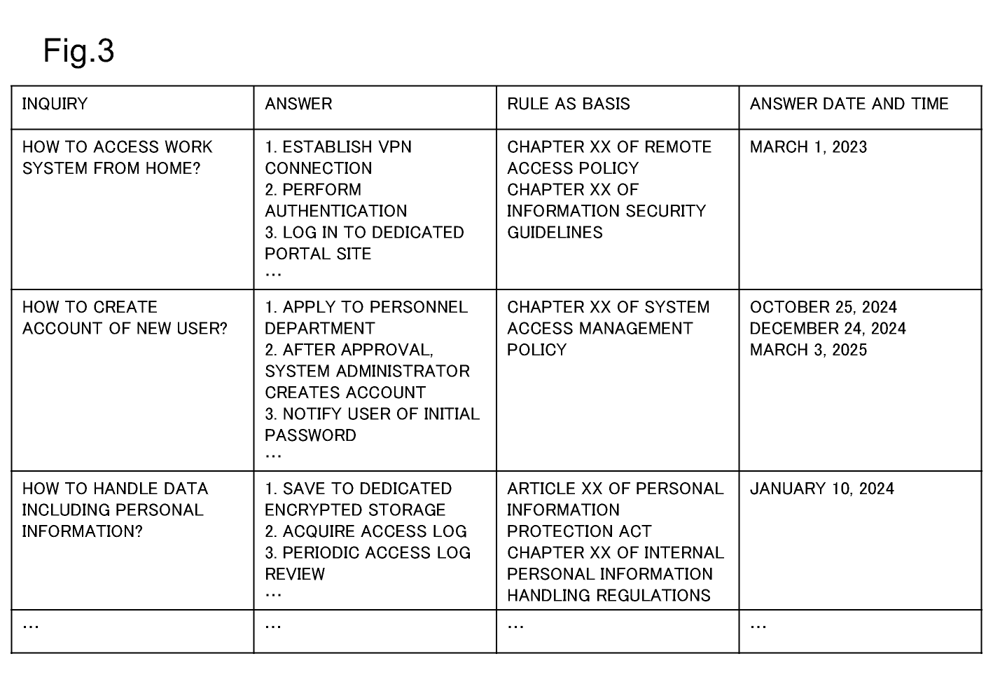

The inquiry-answer collection is a record in which an inquiry acquired in the past, an answer to the inquiry, an answer date and time indicating a date and time at which the answer is made, and a rule as a basis of the answer are associated with each other. Details of the inquiry-answer collection will be described while referring to FIG. 3. FIG. 3 is a diagram illustrating an example of the inquiry-answer collection in the present disclosure. As illustrated in FIG. 3, the inquiry-answer collection includes columns of an inquiry, an answer to the inquiry, a rule as a basis of the answer, and an answer date and time. The column of the inquiry stores a question sentence included in the inquiry accepted from the user. Alternatively, the column of the inquiry may store a summary sentence obtained by summarizing the question sentence. The summary sentence is generated by a generative model such as a large language model. Similarly, the column of the answer to the inquiry stores an answer sentence answered by the worker or a summary sentence of an answer sentence generated by the generative model. The column of the rule as the basis stores identification information of the rule as the basis of the answer. The identification information of the rule is information required for uniquely identifying the rule. For example, the identification information of the rule is a name of a manual or a law, identification (ID), a provision number, the number of pages, or the like.

The identification unit 12 calculates similarity between the inquiry from the user acquired by the inquiry acquisition unit 11 and the inquiry stored in the inquiry-answer collection, thereby identifying a past inquiry similar to the inquiry from the user. For example, the identification unit 12 extracts feature amounts of the inquiry from the user and a sentence of each inquiry included in the inquiry-answer collection. The feature amount is, for example, a term frequency-inverse document frequency (TF-IDF) vector. The identification unit 12 calculates the similarity between the inquiry from the user and each inquiry included in the inquiry-answer collection, by using the extracted feature amounts. The identification unit 12 identifies, as a similar inquiry, an inquiry having a similarity equal to or higher than a predetermined threshold. Alternatively, the identification unit 12 identifies, as similar inquiries, top N inquiries (N is a natural number) having high similarity. A value of N is determined in advance. In a case where there is no inquiry having a similarity equal to or higher than the predetermined threshold, the support device 10 does not perform processing of the rule change history acquisition unit 13 and the determination unit 14 but performs processing of the output unit 15. In this case, the generated output information includes information indicating that there is no past inquiry similar to the inquiry from the user.

The rule change history acquisition unit 13 acquires a change history of a rule associated with the identified inquiry. The rule change history acquisition unit 13 refers to the inquiry-answer collection and identifies a record relevant to the inquiry identified by the identification unit 12. The rule change history acquisition unit 13 acquires a value of a column, which stores identification information of a rule that is a basis of an answer, in the identified record. The rule change history acquisition unit 13 searches the rule database stored in the database server 70 by using the acquired identification information of the rule. In a case where the identification unit 12 identifies a plurality of inquiries, the rule change history acquisition unit 13 acquires a change history of a rule associated with each of the inquiries.

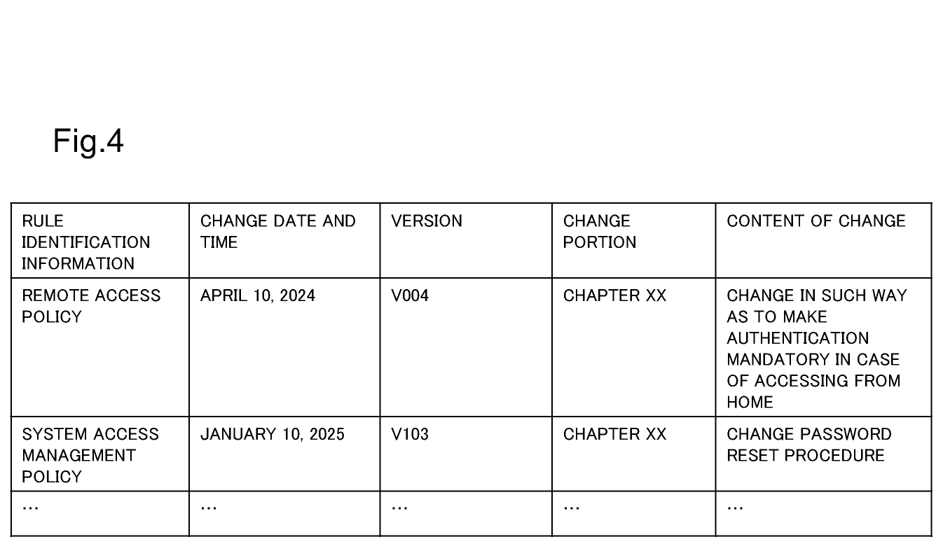

The rule database includes a rule change history table in which identification information of a rule is associated with a date and time at which the rule was changed. Details of the rule change history table will be described while referring to FIG. 4. FIG. 4 is a diagram illustrating an example of a rule change table in the present disclosure. As illustrated in FIG. 4, the rule change history table has columns of the identification information of the rule and the change date and time of the rule. The rule change history table may further include other information. For example, as illustrated in FIG. 4, the rule change history table may further include a column of a rule version, a column of a rule change portion, and a column of change content. The rule change history acquisition unit 13 refers to the rule database and acquires, as a change history, all records relevant to identification information of the identified rule. Alternatively, the rule change history acquisition unit 13 acquires, as the change history, the latest record of the rule associated with the identified inquiry.

The determination unit 14 compares the change history acquired by the rule change history acquisition unit 13 with the answer date and time associated with the inquiry identified by the identification unit 12, and determines whether the rule associated with the inquiry has been changed after the answer date and time. That is, the determination unit 14 determines whether the answer to the inquiry identified by the identification unit 12 is based on a current rule. For example, the determination unit 14 compares the change date and time included in the latest record acquired by the rule change history acquisition unit 13 with the answer date and time associated with the inquiry. In a case where the answer date and time associated with the inquiry is on or after the latest change date and time, the determination unit 14 determines that the rule associated with the inquiry has not been changed after the answer date and time. That is, in this case, the determination unit 14 determines that the answer to the inquiry identified by the identification unit 12 is based on the current rule. In a case where the answer date and time associated with the inquiry is earlier than the latest change date and time, the determination unit 14 determines that the rule associated with the inquiry has been changed after the answer date and time. That is, in this case, the determination unit 14 determines that the answer to the inquiry identified by the identification unit 12 is not based on the current rule. In a case where a plurality of inquiries are identified by the identification unit 12, the determination unit 14 determines, for each inquiry, whether the answer to the inquiry is based on the current rule.

The output unit 15 outputs output information including the answer associated with the inquiry and a result of determination by the determination unit 14. In a case where a plurality of inquiries are identified by the identification unit 12, the output unit 15 outputs, for each identified inquiry, output information including the answer associated with the inquiry and the result of the determination. For example, the output unit 15 outputs the generated output information to the worker terminal 80. An output destination of the output information by the output unit 15 is not limited to the worker terminal 80.

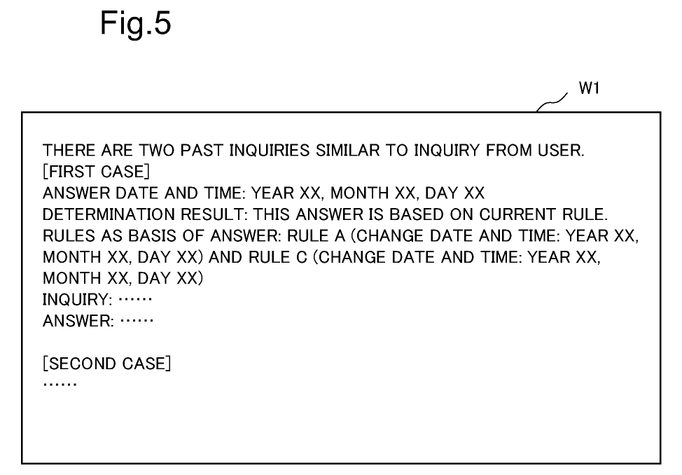

An example of the output information output by the output unit 15 will be described with reference to FIG. 5. FIG. 5 is a diagram illustrating an example of the output information in the present disclosure. As illustrated in FIG. 5, output information W1 includes an answer associated with an inquiry and a result of determination by the determination unit 14. The output information W1 may further include other information. For example, in the example illustrated in FIG. 5, the output information W1 includes a date and time of the answer to the inquiry, a rule that is a basis of the answer to the inquiry, and the inquiry.

### Operation

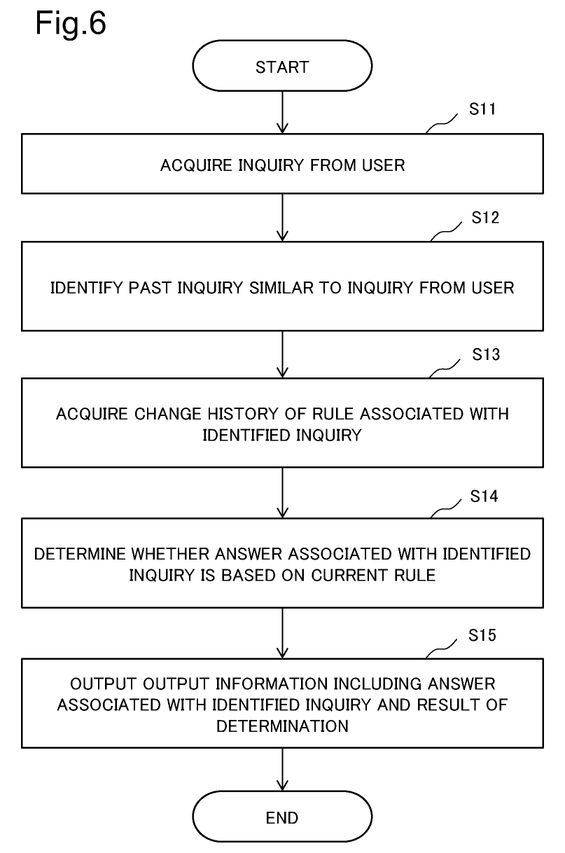

Next, an operation of the support device 10 in the present example embodiment will be described while referring to FIG. 6. FIG. 6 is a flowchart illustrating an example of the operation of the support device in the present disclosure.

First, the inquiry acquisition unit 11 acquires an inquiry from the user (step S11). The inquiry from the user includes a question sentence for a problem related to a service, a product, a system, or the like.

Next, the identification unit 12 calculates similarity between the inquiry from the user acquired by the inquiry acquisition unit 11 and the inquiry stored in the inquiry-answer collection, thereby identifying a past inquiry similar to the inquiry from the user (step S12).

Next, the rule change history acquisition unit 13 acquires a change history of a rule associated with the identified inquiry (step S13). The rule change history acquisition unit 13 refers to the rule database of the database server 70 and acquires a change history of the rule associated with the identified inquiry.

Next, the determination unit 14 compares the change history acquired by the rule change history acquisition unit 13 with the answer date and time associated with the inquiry identified by the identification unit 12, and determines whether the rule associated with the inquiry has been changed after the answer date and time. That is, the determination unit 14 determines whether the answer to the inquiry identified by the identification unit 12 is based on a current rule (step S14).

Next, the output unit 15 outputs output information including the answer associated with the identified inquiry and a result of the determination in step S14 (step S15). If the processing of step S15 is finished, the support device 10 ends the series of processing described above.

As described above, the support device according to the present example embodiment includes an inquiry acquisition unit, an identification unit, a rule change history acquisition unit, a determination unit, and an output unit. The inquiry acquisition unit acquires an inquiry from the user. The identification unit refers to an inquiry-answer collection in which an inquiry acquired in the past, an answer to the inquiry, an answer date and time indicating a date and time at which the answer is made, and a rule as a basis of the answer are associated with each other, and identifies a past inquiry similar to the inquiry from the user. The rule change history acquisition unit acquires a change history of a rule associated with the identified inquiry. The determination unit compares the change history with the answer date and time associated with the identified inquiry, and determines whether the rule associated with the inquiry has been changed after the answer date and time. The output unit outputs output information including the answer associated with the inquiry and a result of determination by the determination unit.

The support device according to the present example embodiment identifies a past inquiry similar to an inquiry from the user, determines whether a rule as a basis of an answer to the past inquiry has been changed after an answer date and time, and outputs output information including a result of the determination and the identified answer. Accordingly, a person who confirms the output information by the support device of the present example embodiment can grasp the past answer to the inquiry similar to the inquiry from the user and whether the past answer is based on a current rule. In other words, according to the support device of the present example embodiment, it is possible to support the help desk worker to be able to answer a question from the user based on the current rule.

In general, in a case of accepting a new inquiry from a user, the help desk worker may provide an answer based on a past record of question and answer. Among inquiries from the user, there is an inquiry that needs to be answered based on a rule such as a law, a regulation, or a manual. In a case where the past record of question and answer is not based on a current rule, there is a possibility that an answer different from the current rule is provided to the user. Therefore, it is desirable to establish a technique for supporting the help desk worker to be able to answer a question from the user based on the current rule.

According to the present disclosure, it is possible to provide the support device, the support method, and the recording medium for supporting a help desk worker to be able to answer a question from a user based on a current rule.

In the support device according to one aspect of the present example embodiment, the inquiry acquisition unit summarizes an inquiry from the user by a generative model. In addition, inquiries included in the inquiry-answer collection are summarized by the generative model. A question sentence from the user may include information other than an essence of the inquiry. The identification unit can improve accuracy of identifying a similar inquiry by comparing the inquiries summarized by the generative model.

In the support device according to one aspect of the present example embodiment, the inquiry acquisition unit inputs, to the generative model, an instruction to make an output format of the summary of the inquiry from the user the same as a format of the inquiry stored in the inquiry-answer collection. Accordingly, the formats of the inquiry from the user and the past inquiry align, and comparison becomes easy, so that the accuracy of identifying a similar inquiry can be improved.

In the support device according to one aspect of the present example embodiment, the output information includes the identified inquiry. Accordingly, the person who confirms the output information can determine whether the identified similar inquiry is appropriate. Then, the person who confirms the output information can utilize an identification result in a case where the identification result is appropriate. In other words, according to the support device of the present example embodiment, it is possible to support the help desk worker to be able to answer a question from the user based on the current rule.

In the support device according to one aspect of the present example embodiment, the output information includes a rule associated with the identified inquiry. By including relevant rules in the output information, the basis of the identified inquiry answer becomes clear. Accordingly, the person who confirms the output information can easily determine whether the answer output by the support device is proper. In other words, according to the support device of the present example embodiment, it is possible to support the help desk worker to be able to answer a question from the user based on the current rule.

In the support device according to one aspect of the present example embodiment, the identification unit identifies, as a similar inquiry, an inquiry, which has a similarity equal to or higher than the predetermined threshold, among the inquiries included in the inquiry-answer collection. In addition, in a case where there is no inquiry having a similarity equal to or higher than the threshold, the output unit outputs output information including information indicating that there is no past inquiry similar to the inquiry from the user, instead of the answer associated with the inquiry and the result of the determination by the determination unit. In a case where there is no past inquiry similar to the inquiry from the user, the support device according to one aspect of the present example embodiment outputs output information including that there is no similar inquiry. Accordingly, the person who confirms the output information can grasp that it is necessary to handle the inquiry as a new one, not based on the past inquiry. In other words, according to the support device of the present example embodiment, it is possible to support the help desk worker to be able to answer a question from the user.

### Second example embodiment

Next, description will be given regarding a support device according to the present example embodiment, with reference to the drawings. In the following description, the same reference signs are given to similar parts to those of the first example embodiment, and description thereof will be omitted as appropriate. The support device of the present example embodiment is different from the support device of the first example embodiment in further including an update unit that updates the inquiry-answer collection.

### Configuration

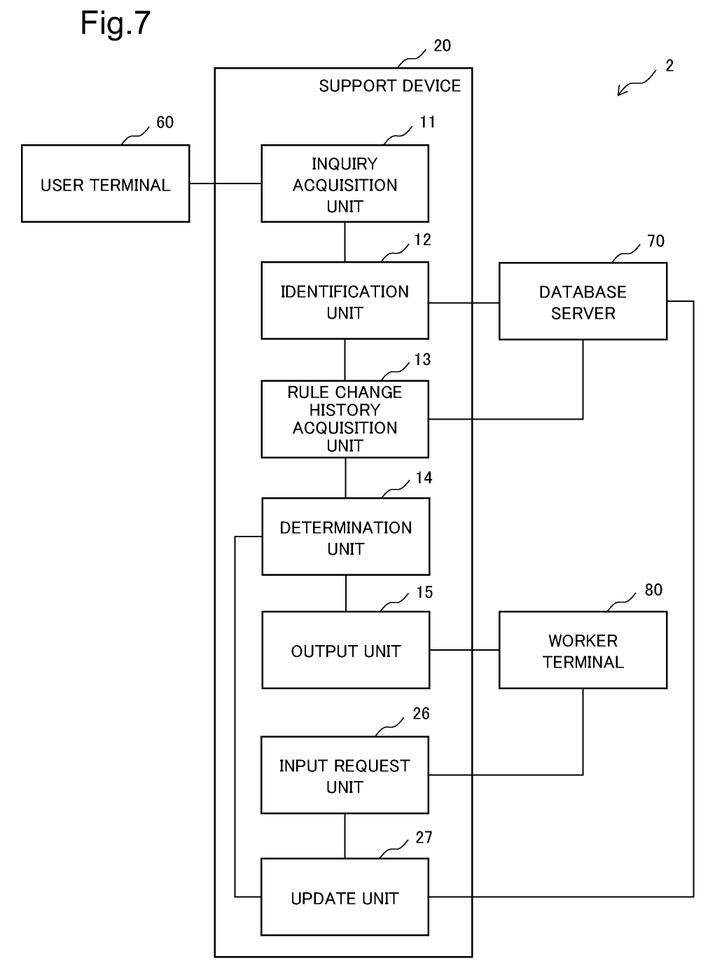

FIG. 7 is a block diagram illustrating an example of the configuration of the support device in the present disclosure. As illustrated in FIG. 7, a support device 20 includes the inquiry acquisition unit 11, the identification unit 12, the rule change history acquisition unit 13, the determination unit 14, the output unit 15, an input request unit 26, and an update unit 27.

The input request unit 26 requests the worker terminal 80 to input whether to reuse the answer to the inquiry identified by the identification unit 12. In addition, the input request unit 26 requests the worker terminal 80 to input an answer to the inquiry from the user.

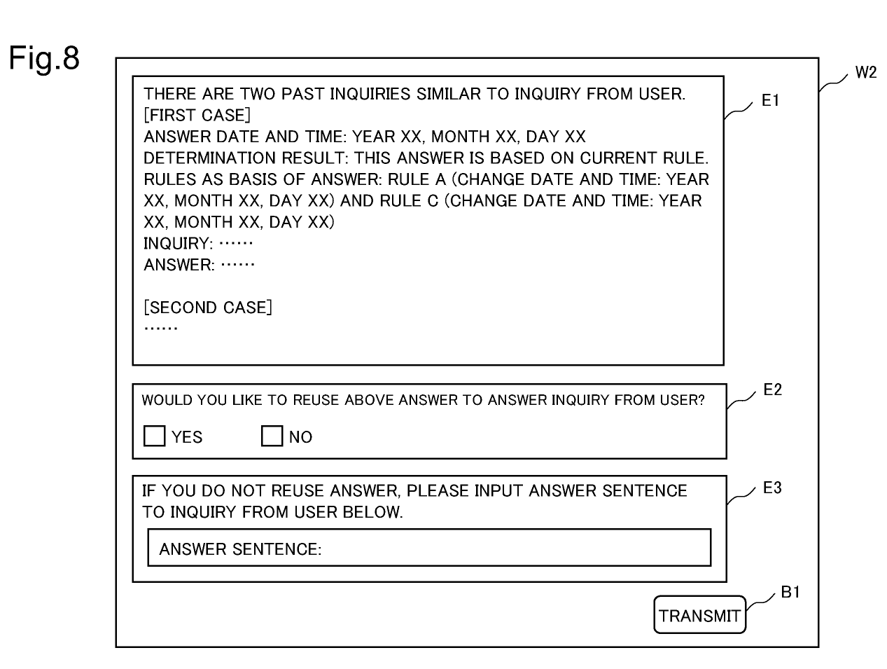

For example, the input request unit 26 causes a display unit of the worker terminal 80 to display an input request screen as illustrated in FIG. 8, thereby requesting input of the answer to the inquiry from the user. FIG. 8 is a diagram illustrating an example of the input request screen in the present disclosure. The input request unit 26 causes the display unit of the worker terminal 80 to display an input request screen W2 as illustrated in FIG. 8. The input request screen W2 includes output information E1, a UI component E2 that requests input as to whether to reuse the answer to the inquiry, and a UI component E3 that requests input of an answer sentence to the inquiry from the user. The output information E1 is output information generated by the output unit 15. The input request screen W2 may not include the output information. The UI component E2 is a UI component that accepts the input as to whether to reuse the answer to the inquiry identified by the identification unit 12. A worker who confirms the input request screen W2 selects a check box of “Yes” in a case of reusing the answer to the inquiry identified by the identification unit 12. In addition, the worker selects a check box of “No” in a case of not reusing the answer to the inquiry identified by the identification unit 12. The UI component E3 is a UI component that requests input of an answer sentence to the inquiry from the user in a case where “No” is selected by the UI component E2. The worker who confirms the input request screen W2 inputs an answer sentence to the user in a text box. If all the inputs are finished, the worker presses a button B1. If it is detected that the button B1 is pressed, the worker terminal 80 transmits the input information to the support device 20. The input request unit 26 acquires the input information transmitted from the worker terminal 80.

The update unit 27 updates the inquiry-answer collection by using the information accepted by the input request unit 26. In a case of accepting the input to reuse the answer to the inquiry identified by the identification unit 12, the update unit 27 updates a date of the answer date and time included in an entry of the inquiry-answer collection identified by the identification unit 12. Specifically, the update unit 27 overwrites the answer date and time included in the entry with date and time at which the input request unit 26 accepted the input. In this case, the update unit 27 does not change the content of the answer included in the entry. On the other hand, in a case of accepting the input of the answer sentence to the inquiry identified by the identification unit 12, the update unit 27 updates the content and the answer date and time of the answer included in the entry. Specifically, the update unit 27 overwrites the content of the answer included in the entry with the answer sentence for which the input is accepted by the input request unit 26. In addition, the update unit 27 overwrites the answer date and time included in the entry with the date and time at which the input request unit 26 accepted the input.

### Operation

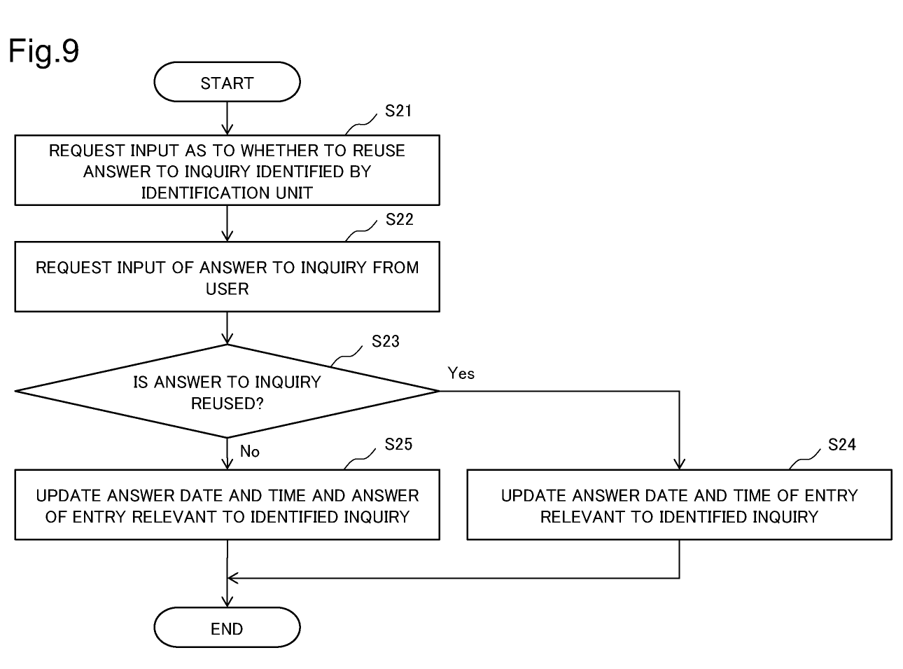

Next, an operation of the support device 20 will be described with reference to FIG. 9. FIG. 9 is a flowchart illustrating an example of the operation of the support device in the present disclosure. The operation shown in FIG. 9 is executed after the processing of steps S11 to S15, which are the operations described with reference to FIG. 6 in the first example embodiment, is finished.

First, the input request unit 26 requests the worker terminal 80 to input whether to reuse the answer to the inquiry identified by the identification unit 12 (step S21). In addition, the input request unit 26 requests the worker terminal 80 to input an answer to the inquiry from the user (step S22). In a case where an input of “do not reuse” is accepted from the worker terminal 80 in step S21, the input request unit 26 may not execute the processing of step S22.

In a case of accepting an input indicating that the answer to the inquiry is reused (Yes in step S23), the update unit 27 updates the answer date and time of the entry relevant to the inquiry identified by the identification unit 12 (step S24).

In a case of accepting an input indicating that the answer to the inquiry is not reused (No in step S23), the update unit 27 updates the answer date and time and the answer of the entry relevant to the inquiry identified by the identification unit 12 (step S25). The answer used at a time of update is the answer for which the input is accepted in step S22. If the processing of step S24 or step S25 is finished, the support device 20 ends the series of processing described above.

The support device of the present example embodiment is configured as described above. The support device in the present example embodiment has the following effects in addition to the effects obtained from the support device of the first example embodiment.

The support device according to one aspect of the present example embodiment further includes an input request unit and an update unit. The input request unit requests an input as to whether to reuse the answer associated with the identified inquiry. In a case of accepting an input indicating that the answer associated with the identified inquiry is not reused, the update unit updates the answer associated with the identified inquiry. By updating the answer in the inquiry-answer collection when it is determined not to be reused, the person who confirms the inquiry-answer collection can grasp that the inquiry answer has been recently verified or has been newly created. According to the support device of one aspect of the present example embodiment, it is possible to enhance reliability of the inquiry answer for the person who confirms the inquiry-answer collection.

The support device according to one aspect of the present example embodiment further includes an input request unit and an update unit. The input request unit requests an input of the answer to the inquiry from the user. The update unit updates the answer date and time and the answer associated with the identified inquiry by using the input information. The support device according to one aspect of the present example embodiment accepts an input of a new answer to the inquiry and updates an existing entry of the inquiry-answer collection. That is, the inquiry data stored in the inquiry-answer collection is updated based on the current rule. In other words, according to the support device of one aspect of the present example embodiment, it is possible to support the help desk worker to be able to answer a question from the user based on the current rule.

### Third example embodiment

In the present example embodiment, a support device 30 having a configuration in which the support devices in the first example embodiment and the second example embodiment are simplified will be described. In the following description, description of parts similar to those in the first example embodiment and the second example embodiment will be omitted as appropriate.

### Configuration

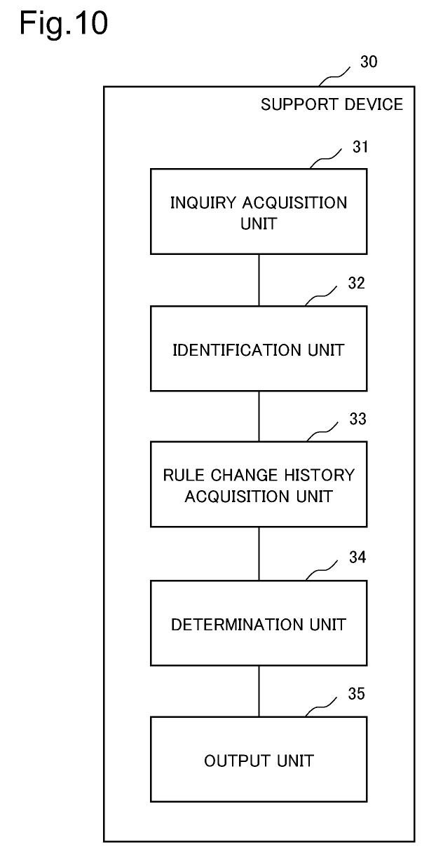

Description will be given regarding the configuration of the support device in the present example embodiment, with reference to the drawings. FIG. 10 is a block diagram illustrating an example of the configuration of the support device in the present disclosure. The support device 30 includes an inquiry acquisition unit 31, an identification unit 32, a rule change history acquisition unit 33, a determination unit 34, and an output unit 35.

The inquiry acquisition unit 31 acquires an inquiry from the user. The identification unit 32 refers to an inquiry-answer collection in which an inquiry acquired in the past, an answer to the inquiry, an answer date and time indicating a date and time at which the answer is made, and a rule as a basis of the answer are associated with each other, and identifies a past inquiry similar to the inquiry from the user. The rule change history acquisition unit 33 acquires a change history of a rule associated with the identified inquiry. The determination unit 34 compares the change history with the answer date and time associated with the identified inquiry, and determines whether the rule associated with the identified inquiry has been changed after the answer date and time. The output unit 35 outputs output information including the answer associated with the identified inquiry and a result of the determination.

### Operation

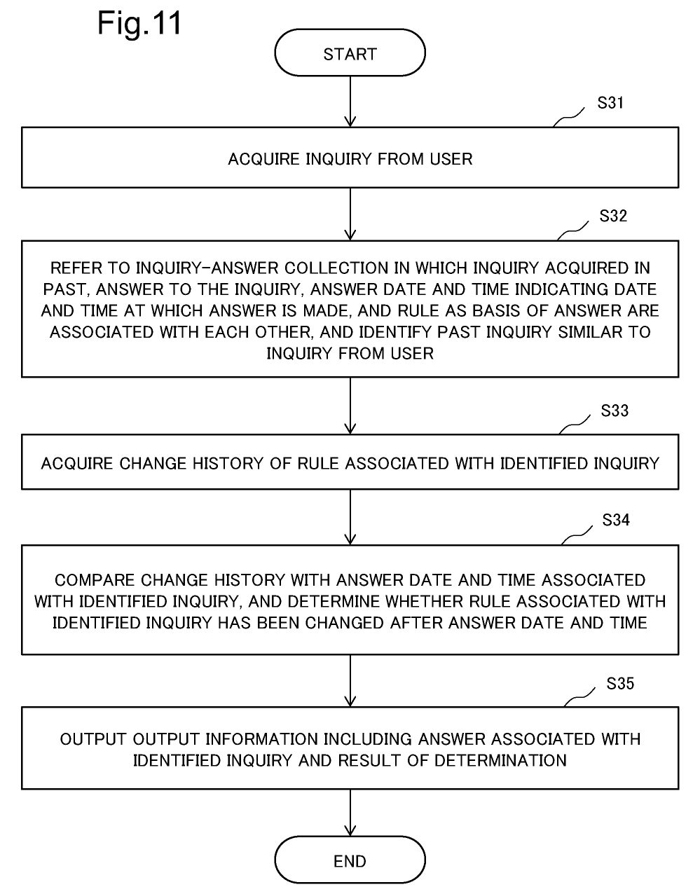

Next, description will be given regarding an example of an operation of the support device in the present example embodiment, with reference to FIG. 11. FIG. 11 is a flowchart illustrating the example of the operation of the support device in the present disclosure.

First, the inquiry acquisition unit 31 acquires an inquiry from the user (step S31).

Next, the identification unit 32 refers to an inquiry-answer collection in which an inquiry acquired in the past, an answer to the inquiry, an answer date and time indicating a date and time at which the answer is made, and a rule as a basis of the answer are associated with each other, and identifies a past inquiry similar to the inquiry from the user (step S32).

Next, the rule change history acquisition unit 33 acquires a change history of a rule associated with the identified inquiry (step S33).

Next, the determination unit 34 compares the change history with the answer date and time associated with the identified inquiry, and determines whether the rule associated with the identified inquiry has been changed after the answer date and time (step S34).

Next, the output unit 35 outputs output information including the answer associated with the identified inquiry and a result of the determination (step S35).

The support device of the present example embodiment is configured as described above. The output information generated by the support device of the present example embodiment includes a past answer to an inquiry similar to the inquiry from the user and whether the past answer is based on a current rule. Accordingly, the help desk worker or the like who confirms the output information can grasp the past answer to the inquiry similar to the inquiry from the user and whether the past answer is based on the current rule. That is, according to the support device of the present example embodiment, it is possible to support the help desk worker to be able to answer a question from the user based on the current rule.

### Hardware configuration

Each component described above in each example embodiment of the present disclosure can be achieved as hardware and further achieved by a computing device or firmware based on program control.

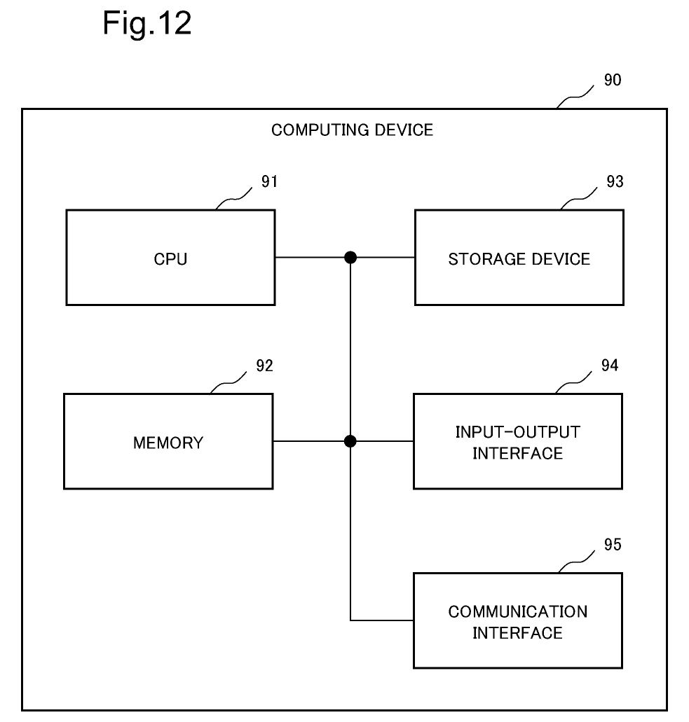

FIG. 12 is a diagram illustrating an example of a hardware configuration in which the support device in the present disclosure is achieved by a computing device 90 including a processor. The support device of each example embodiment is achieved by the computing device 90. As illustrated in FIG. 12, the computing device 90 includes a processor 91, a memory 92, a storage device 93, such as a hard disk, that stores a program, an input-output interface 94 for connection to an input device and an output device, and a communication interface 95 for network connection.

The processor 91 loads programs (commands) stored in the storage device 93 and the like into the memory 92. For example, the programs are software programs for executing control and processing in the present disclosure. The processor 91 executes the programs loaded into the memory 92. The processor 91 executes the control and the processing in the present disclosure by executing the programs.

Examples of the storage device 93 include an optical disc, a flexible disk, a magneto-optical disk, an external hard disk, and a semiconductor memory. Some of storage media included in the storage device are non-volatile storage devices, and record therein programs. The programs may be downloaded from an external computer (not illustrated) connected to a communication network.

The input device connected to the input-output interface 94 is achieved by a mouse or a keyboard, for example, and is used for input operation. Similarly, the output device connected to the input-output interface 94 is achieved by a display, for example, and is used for display and confirmation of an output result.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

One, some, or all of the above example embodiments can also be described as supplementary notes below.

### Supplementary Note 1

A support device including:

an inquiry acquisition means for acquiring an inquiry from a user;

an identification means for referring to an inquiry-answer collection in which the inquiry acquired in the past, an answer to the inquiry, an answer date and time indicating a date and time at which the answer is made, and a rule as a basis of the answer are associated with each other, and identifying a past inquiry similar to the inquiry from the user;

a rule change history acquisition means for acquiring a change history of the rule associated with the identified inquiry;

a determination means for comparing the change history with the answer date and time associated with the identified inquiry and determining whether the rule associated with the identified inquiry has been changed after the answer date and time; and

an output means for outputting output information including the answer associated with the identified inquiry and a result of the determination.

### Supplementary Note 2

The support device according to Supplementary Note 1, in which

the inquiry acquisition means summarizes the inquiry from the user using a generative model, and

the inquiry included in the inquiry-answer collection is summarized by the generative model.

### Supplementary Note 3

The support device according to Supplementary Note 2, in which the inquiry acquisition means summarizes the inquiry from the user by inputting, to the generative model, an instruction to make an output format of a summary of the inquiry from the user the same as a format of the inquiry stored in the inquiry-answer collection.

### Supplementary Note 4

The support device according to any one of Supplementary Notes 1 to 3, in which the output information includes the identified inquiry.

### Supplementary Note 5

The support device according to any one of Supplementary Notes 1 to 4, in which the output information includes the rule associated with the identified inquiry.

### Supplementary Note 6

The support device according to any one of Supplementary Notes 1 to 5, in which

the identification means identifies, as a similar inquiry, an inquiry, which has a similarity equal to or higher than a predetermined threshold, among the inquiries included in the inquiry-answer collection, and

in a case where there is no inquiry having a similarity equal to or higher than the threshold, the output means outputs the output information including information indicating that there is no past inquiry similar to the inquiry from the user, instead of the answer associated with a past inquiry and the result of the determination.

### Supplementary Note 7

The support device according to any one of Supplementary Notes 1 to 6, further including:

an input request means for requesting an input as to whether to reuse the answer associated with the identified inquiry; and

an update means for updating the answer and time to a current date and time associated with the identified inquiry in a case where an input indicating that the answer is not reused is accepted.

### Supplementary Note 8

The support device according to any one of Supplementary Notes 1 to 6, further including:

an input request means for requesting an input of an answer to the inquiry from the user; and

an update means for updating the answer date and time associated with the identified inquiry and the answer associated with the identified inquiry by using the inputted answer.

### Supplementary Note 9

A support method which causes a computer to execute:

acquiring an inquiry from a user;

referring to an inquiry-answer collection in which the inquiry acquired in the past, an answer to the inquiry, an answer date and time indicating a date and time at which the answer is made, and a rule as a basis of the answer are associated with each other, and identifying a past inquiry similar to the inquiry from the user;

acquiring a change history of the rule associated with the identified inquiry;

comparing the change history with the answer date and time associated with the identified inquiry and determining whether the rule associated with the identified inquiry has been changed after the answer date and time; and

outputting output information including the answer associated with the identified inquiry and a result of the determination.

### Supplementary Note 10

A computer program which causes a computer to execute:

processing of acquiring an inquiry from a user;

processing of referring to an inquiry-answer collection in which the inquiry acquired in the past, an answer to the inquiry, an answer date and time indicating a date and time at which the answer is made, and a rule as a basis of the answer are associated with each other, and identifying a past inquiry similar to the inquiry from the user;

processing of acquiring a change history of the rule associated with the identified inquiry;

processing of comparing the change history with the answer date and time associated with the identified inquiry and determining whether the rule associated with the identified inquiry has been changed after the answer date and time; and

processing of outputting output information including the answer associated with the identified inquiry and a result of the determination.

In the supplementary notes described above, one, some, or all of the configurations described in Supplementary Notes 2 to 8 dependent on Supplementary Note 1 can also be dependent on Supplementary Notes 9 and 10 in accordance with the same dependency relation as in Supplementary Notes 2 to 8. Further, one, some, or all of the configurations described as the supplementary notes can be similarly dependent on not only Supplementary Notes 1, 9, and 10 but also various pieces of hardware and various systems without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A support device comprising:
one or more memories storing instructions; and
one or more processors configured to execute the instructions to:
acquire an inquiry from a user;
refer to an inquiry-answer collection in which the inquiry acquired in the past, an answer to the inquiry, an answer date and time indicating a date and time at which the answer is made, and a rule as a basis of the answer are associated with each other, and identify a past inquiry similar to the inquiry from the user;
acquire a change history of the rule associated with the identified inquiry;
compare the change history with the answer date and time associated with the identified inquiry and determine whether the rule associated with the identified inquiry has been changed after the answer date and time; and
output output information including the answer associated with the identified inquiry and a result of the determination.

2. The support device according to claim 1, wherein
the one or more processors are configured to execute the instructions to summarize the inquiry from the user using a generative model, and
the inquiry included in the inquiry-answer collection is summarized by the generative model.

3. The support device according to claim 2, wherein the one or more processors are configured to execute the instructions to summarize the inquiry from the user by inputting, to the generative model, the inquiry from the user and an instruction to output a summary in the same format as a format of the inquiries stored in the inquiry-answer collection.

4. The support device according to claim 1, wherein the output information includes the identified inquiry.

5. The support device according to claim 1, wherein the output information includes the rule associated with the identified inquiry.

6. The support device according to claim 1, wherein
the one or more processors are configured to execute the instructions to:
identify, as a similar inquiry, an inquiry, which has a similarity equal to or higher than a predetermined threshold, among the inquiries included in the inquiry-answer collection; and
in a case where there is no inquiry having a similarity equal to or higher than the threshold, output the output information including information indicating that there is no past inquiry similar to the inquiry from the user, instead of the answer associated with a past inquiry and the result of the determination.

7. The support device according to claim 1, wherein
the one or more processors are further configured to execute the instructions to:
request an input as to whether to reuse the answer associated with the identified inquiry; and
update the answer and time associated with any identified inquiry to a current date and time in a case where an input indicating that the answer is not reused is accepted.

8. The support device according to claim 1, wherein
the one or more processors are further configured to execute the instructions to:
request an input of an answer to the inquiry from the user; and
update the answer date and time associated with the identified inquiry and the answer associated with the identified inquiry by using the inputted answer.

9. The support device according to claim 1, wherein the one or more processors are further configured in such a way as to summarize the inquiry from the user by using a machine learning model, and the inquiry stored in the inquiry-answer collection is an inquiry that has been summarized by the machine learning model.

10. The support device according to claim 1, wherein the output information is used to support an operator's decision making regarding whether to reuse a past answer associated with the identified inquiry or to create a new answer based on a current rule.

11. A support method comprising:
by a computer,
acquiring an inquiry from a user;
referring to an inquiry-answer collection in which the inquiry acquired in the past, an answer to the inquiry, an answer date and time indicating a date and time at which the answer is made, and a rule as a basis of the answer are associated with each other, and identifying a past inquiry similar to the inquiry from the user;
acquiring a change history of the rule associated with the identified inquiry;
comparing the change history with the answer date and time associated with the identified inquiry and determining whether the rule associated with the identified inquiry has been changed after the answer date and time; and
outputting output information including the answer associated with the identified inquiry and a result of the determination.

12. A non-transitory recording medium having recorded thereon a computer program which causes a computer to execute:
processing of acquiring an inquiry from a user;
processing of referring to an inquiry-answer collection in which the inquiry acquired in the past, an answer to the inquiry, an answer date and time indicating a date and time at which the answer is made, and a rule as a basis of the answer are associated with each other, and identifying a past inquiry similar to the inquiry from the user;
processing of acquiring a change history of the rule associated with the identified inquiry;
processing of comparing the change history with the answer date and time associated with the identified inquiry and determining whether the rule associated with the identified inquiry has been changed after the answer date and time; and
processing of outputting output information including the answer associated with the identified inquiry and a result of the determination.
